(19) United States
(12) Patent Application Publication
(10) Pub. No.: US 2009/0198930 A1
(43) Pub. Date: Aug. 6, 2009

(54) INFORMATION BACKUP SYSTEM FOR HANDHELD DEVICES

(76) Inventors: Simon B. Johnson, Bonney Lake, WA (US); Lev M. Bolotin, Kirkland, WA (US)

Correspondence Address: LAW OFFICES OF MIKIO ISHIMARU, 333 W. EL CAMINO REAL, SUITE 330, SUNNYVALE, CA, 94087, US

(21) Appl. No.: 12/303,114

(22) PCT Filed: Jun. 1, 2007
(86) PCT No.: PCT/US07/70283

§ 371 Date: Dec. 1, 2008

Related U.S. Application Data
(60) Provisional application No. 60/803,711, filed on Jun. 1, 2006.

(51) Int. Cl. G06F 12/16; G06F 12/00

(52) U.S. Cl. 711/162; 711/E12.103; 711/E12.001

(57) ABSTRACT

An information backup system [700] is provided including receiving information from a memory in a handheld device [104]; writing the information into a removable non-volatile memory [106] in an information backup device [102]; and rewriting the information from the removable non-volatile memory [106] into a different handheld device [204].

### CROSS-REFERENCE TO RELATED APPLICATION(S)

This application claims the benefit of U.S. Provisional Patent Application Ser. No. 60/803,711 filed Jun. 1, 2006.

### TECHNICAL FIELD

The present invention relates generally to handheld devices, and more particularly to cell phones having built-in memory.

### BACKGROUND ART

Handheld devices, such as palm computers and cell phones, have become widely available and very popular for personal use. For example, cell phones are most commonly used while the user is outside of the home or office. Many problems may arise while a cell phone is being used in this manner. The cell phone may be easily damaged, misplaced, or lost. When this happens, any information stored in the cell phone is lost as well. Often, this information does not exist anyplace other than in the memory of the cell phone. Sometimes, the information can be laboriously re-entered from other sources. Often, the information is irretrievably lost.

Some small devices have been developed for backing up cell phone memories. One is about the size of a Universal Serial Bus (USB) Flash drive and comes equipped with a USB connector for managing contacts via a computer. Information is stored in its integral non-volatile memory.

Another device is battery powered with an interchangeable tip for connecting to various cell phone models. Again, information is stored in an integral non-volatile memory.

Some systems allow editing and transferring of cell phone entries between the cell phone and Outlook® or Outlook Express® programs on a personal computer.

A number of solutions have been created but have difficulty addressing the problem of being able to take information backed up from one cell phone and transferring it to a replacement cell phone of a different make and model. Existing solutions are good at restoring information back to an identical phone but have trouble adapting the information to another model possessing a different communication interface.

Given the rapid change and “mass customization” in cell phone technology, it is often difficult to replace a lost, damaged, or stolen cell phone with the exact same model. This results in the need to retrieve and/or recreate information for a brand new cell phone

A solution to this problem has long been sought but prior developments have not taught or suggested any solutions and, thus, a solution to this problem has long eluded those skilled in the art.

### DISCLOSURE OF THE INVENTION

The present invention provides an information backup system including receiving information from a memory in a handheld device; writing the information into a removable non-volatile memory in an information backup device; and rewriting the information from the removable non-volatile memory into a different handheld device.

Certain embodiments of the invention have other aspects in addition to or in place of those mentioned above. The aspects will become apparent to those skilled in the art from a reading of the following detailed description when taken with reference to the accompanying drawings.

### BRIEF DESCRIPTION OF THE DRAWINGS

FIG. 1 is a hardwired information backup system in accordance with an embodiment of the present invention;

FIG. 2 is a wireless information backup system in accordance with another embodiment of the present invention;

FIG. 3 is a hardwire backup device in accordance with another embodiment of the present invention;

FIG. 4 is a wireless backup device in accordance with another embodiment of the present invention;

FIG. 5 is an information backup system in accordance with another embodiment of the present invention, which includes a computer;

FIG. 6 is a universal backup device in accordance with another embodiment of the present invention; and

FIG. 7 is a flow chart of an exemplary information backup system operating in accordance with the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

Likewise, the drawings showing embodiments of the system are semi-diagrammatic and not to scale and, particularly, some of the dimensions are for the clarity of presentation and are shown greatly exaggerated in the drawing FIGS.

The term “handheld device” is meant to include devices such as personal digital assistants (PDAs), personal use navigation (GPS) systems, iPods, cell phones, mini tablet computers, et cetera. The term “cell phone” is meant to include traditional cell phones as well as “smart” phones including digital screens, built-in computers, Internet connection devices, cordless phones, and other phones with add-on features such as cameras and music-video capability that are becoming more popular as integral components of the basic cell phone.

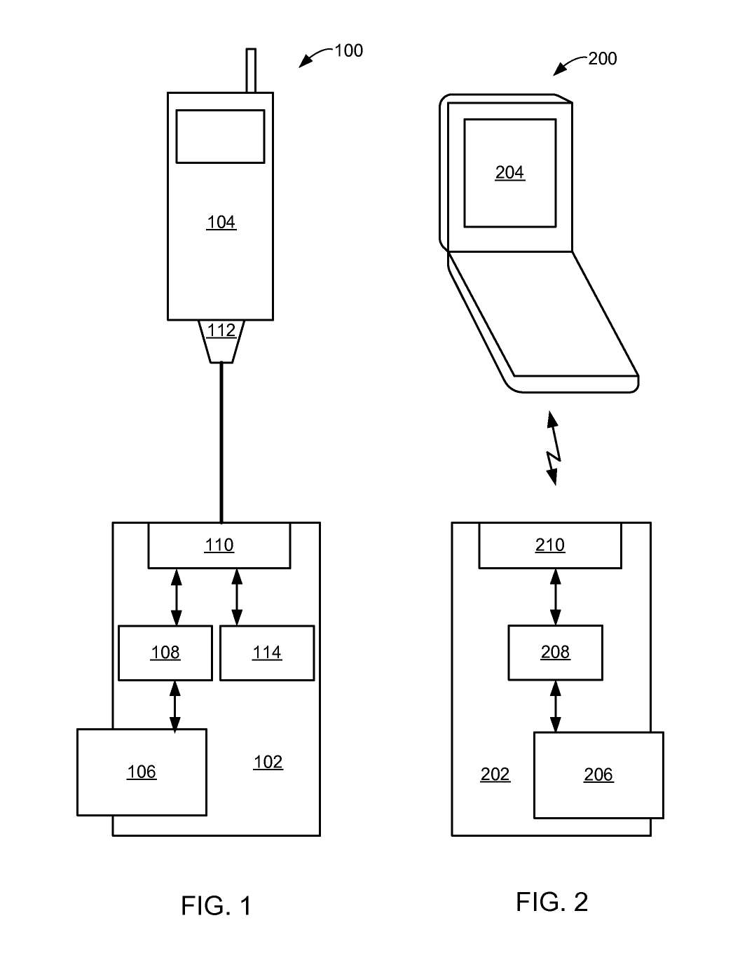

Referring now to FIG. 1, therein is shown a hardwired information backup system 100 in accordance with an embodiment of the present invention. The hardwired information backup system 100 includes a backup device 102 and a handheld device 104.

The removable memory module 106 is capable of being installed into another information backup system that is compatible with a different type of handheld device (such as handheld device 204 of FIG. 2).

When installed, the removable memory module 106 is connected to a microcontroller 108, which is a specialized microprocessor. The microcontroller 108 is connected to an electrical connector module 110, which is connected by a cord to a hardwire connector 112 for the particular handheld device 104. The electrical connector module 110 may also be connected to a charger 114 for charging a rechargeable battery (not shown) in the handheld device 104.

The backup device 102 may be powered from the power supply of the handheld device 104, an internal device power supply, or from the handheld device's charger 114.

The removable memory module 106 can be exchanged between various embodiments of the present invention because it has a “common” format. Communication ports and protocols among handheld devices are very diverse. For example, there are almost as many cell phone interfaces as there are cell phone models. If a new phone is acquired that is not compatible with an existing backup system, the removable memory module of the backup system can be installed in a new backup system having the appropriate microprocessor to facilitate information restoration to the newly acquired phone.

For handheld devices 104 having the same connector configuration as the hardwire connector 112, information regarding the communication information including handshake signals, the baud rate, the voltages, and the connector pin configuration can be stored with the microcontroller 108 and/or the removable memory module 106.

The removable memory module 106 can be a Flash card, a USB Flash drive, or any other type of portable memory. Information is stored in a format that can be read/written by a computer application in addition to being read/written by the backup device 102.

Referring now to FIG. 2, therein is shown a wireless information backup system 200 in accordance with another embodiment of the present invention. The wireless information backup system 200 a wireless backup device 202 and a wireless handheld device 204, for example, such as a Bluetooth cell phone.

The wireless backup device 202 includes a removable non-volatile memory module 206, which is connectable to a microcontroller 208.

The microcontroller 208 is connected to a radio frequency (RF) transceiver 210, which communicates via Bluetooth or infrared with the handheld device 204.

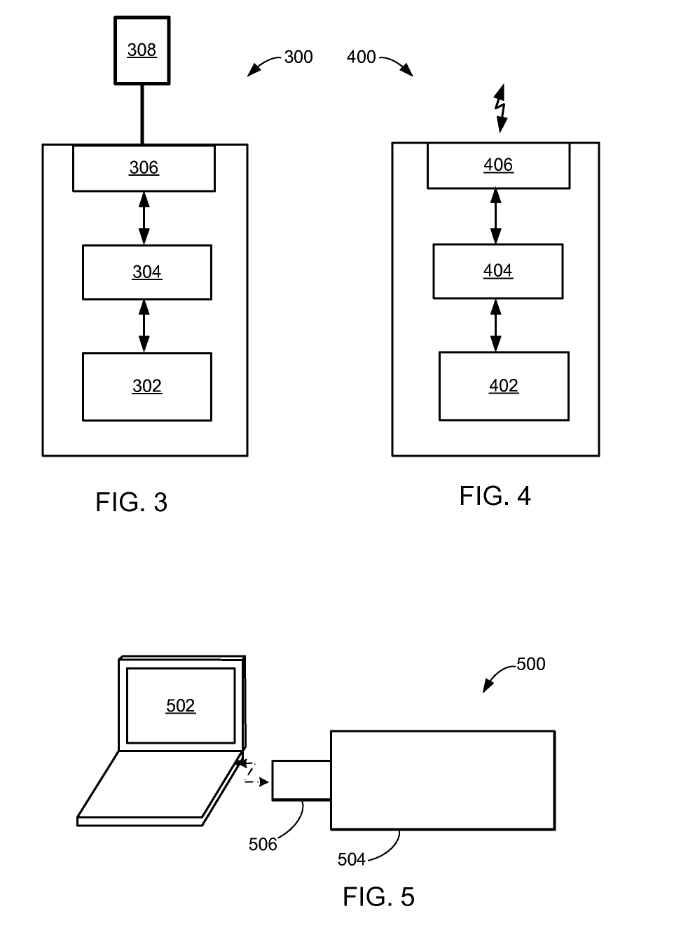

Referring now to FIG. 3, therein is shown a hardwire backup device 300 in accordance with another embodiment of the present invention. The hardwire backup device 300 includes a removable memory module 302, a microcontroller 304, and an electrical connector module 306 with a wire connection 308.

The wire connection 308 is removable and can be replaced with a connection of a different configuration so as to be adaptable to different handheld devices. This may use replaceable connector tips as well.

The microcontroller 304 is responsible for communication information including handshaking with the handheld device to read/write information. The microcontroller 304 interfaces with the electrical connector module 306 and supplies a communication channel which operates for a number of different makes and models of handheld devices.

Referring now to FIG. 4, therein is shown a wireless backup device 400 in accordance with another embodiment of the present invention. The wireless backup device 400 includes a removable non-volatile memory module 402 connectable to a microcontroller 404. The microcontroller 404 is connected with a transceiver 406 that provides a RF or infrared frequency communication channel. In particular, if the handheld device is a cell phone, which supports the Bluetooth communication standard, the same backup device 400 is capable of supporting most cell phones using this standard.

Referring now to FIG. 5, therein is shown an information backup system 500 in accordance with another embodiment of the present invention, which includes a computer 502. The information backup system 500 includes a removable memory module 504 similar to the removable memory modules, 206, 302, and 402. The removable memory module 504 has a USB connector 506 which can be connected to a computer, such as the portable computer 502. This permits the removable memory module 504 to be accessed directly by a host computer equipped with a memory module reader. This facilitates transfers, not only between information backup systems, but computers as well. This permits editing of information that can then be transferred back to the information backup system and to the handheld device.

Furthermore, the information can be formatted within a NAND Flash device or backup module so it is compatible with existing computer applications. For example, for a cell phone contact applications such as Outlook® and Thunderbird® may be used. The information backup system 500 appears as a standard USB Flash drive to the computer 502. Thus, cell phone information becomes immediately available to all computer resident applications.

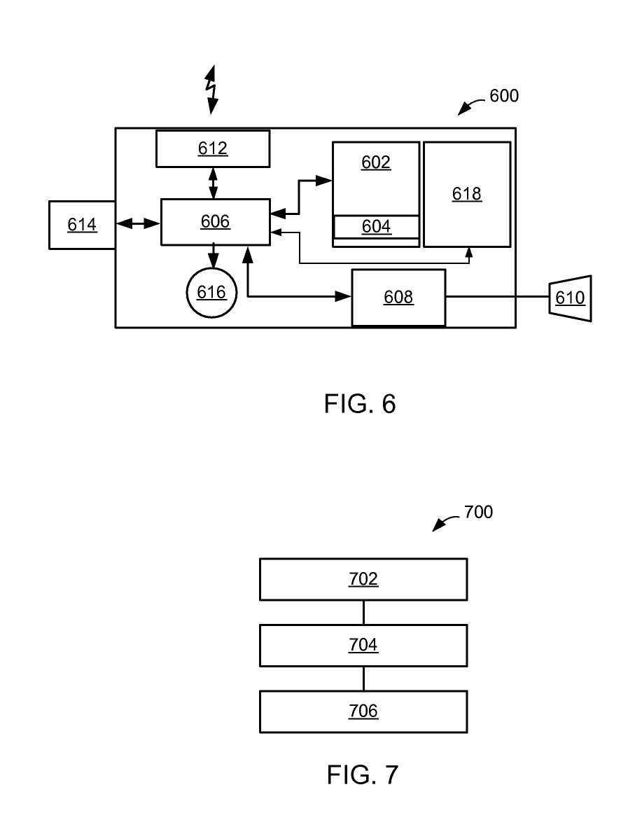

Referring now to FIG. 6, therein is shown a universal backup device 600 in accordance with another embodiment of the present invention. The universal backup device 600 contains a removable memory module 602 and a non-removable memory module 604. The memory modules 602 and 604 are connected to a microcontroller 606.

The microcontroller 606 is connected to an electrical connector module 608 for a hardwire connector 610. The microcontroller 606 is connected to a wireless connector module 612 and to a USB connector 614. The microcontroller 606 is further connected to an indicator, or LED 616, to indicate when an information backup is taking place.

The universal backup device 600 is capable of automatic detection of different handheld devices to initiate appropriate information backup. This occurs by detecting either connection to the hardwire connector 610 or the USB connector 614 or by proximity to the wireless connector module 612.

The universal backup device 600 is capable of transferring information between a computer, internal/external storage through the universal backup device 600 to a handheld device or a computer to erasable memory, which permits the making of incremental backups so as to be able to save the most recent information. The non-removable memory module 604 contains information files 618, which permit storage of configuration and interfacing data of most makes and models of handheld devices.

It should be noted that the universal backup device 600 can also be incorporated in such devices as a memory stick, Flash memory card, or Subscriber Identification Module (SIM) card.

While it is possible to have a unique set of communication commands for each make and model of cell phone, most mobile communications (GSM) phones use an extended version of the standard “Attention” (AT) command set. For example, the command “AT+CPBR” is used to retrieve a cell phone book entry, whether the connection is made by hardwire or wireless. Once the channel has been opened, the same command format applies. Thus, a universal backup system with a Bluetooth interface supplies the broadest compatibility on different makes and models of cell phones.

Referring now to FIG. 7, therein is shown a flow chart for an information backup system 700 which includes receiving information from a memory in a handheld device in a block 702; writing the information into a removable non-volatile memory in an information backup device in a block 704; and rewriting the information from the removable non-volatile memory into a different handheld device in a block 706.

While the invention has been described in conjunction with a specific best mode, it is to be understood that many alternatives, applications, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. An information backup system [700] comprising:
receiving information from a memory in a handheld device [104];
writing the information into a removable non-volatile memory [106] in an information backup device [102]; and
rewriting the information from the removable non-volatile memory into a memory in a different handheld device [204].

2. The system as claimed in claim 1 wherein receiving information includes receiving information through a hardwire, wirelessly, a universal serial bus connector, or a combination thereof [110, 210, 506].

3. The system as claimed in claim 1 further comprising moving the removable non-volatile memory between the information backup device [102] and a different information backup device [202].

4. The system as claimed in claim 1 wherein writing the information includes writing the information in a computer accessible file format.

5. The system as claimed in claim 1 wherein receiving and rewriting the information includes automatically identifying the handheld device [104] and the different handheld device [204].

6. An information backup system [700] comprising:
receiving communication information from a memory in a handheld device [104];
providing responding communication information from an information backup device [102];
releasing data information from the memory in the handheld device [104] in response to the responding communication information to the information backup device [102];
writing the data information into a removable non-volatile memory in an information backup device [102];
receiving communication information from a memory in a different handheld device [204];
providing responding communication information to the different handheld device [204] from the information backup device [102]; and
rewriting the data information from the removable non-volatile memory in the information backup device [102] to the memory in the different handheld device [204].

7. The system as claimed in claim 6 wherein receiving information includes receiving and rewriting information through a hardwire, wirelessly, a universal serial bus connector, or a combination thereof [110, 210, 506].

8. The system as claimed in claim 6 further comprising moving the removable non-volatile memory between the information backup device [102] for the handheld device [104] and a different information backup device [202] for a different handheld device [204].

9. The system as claimed in claim 6 wherein writing the information includes writing the information in a computer [502] accessible file format for a personal computer [502].

10. The system as claimed in claim 6 wherein receiving and rewriting the information includes automatically identifying and assuring compatibility between the handheld device [104] [204] and the different handheld device [204].

11. An information backup system [100] comprising:
a handheld device [104] including a memory for sending information;
an information backup device [102] having a removable non-volatile memory for receiving and writing the information from the memory in the handheld device [104] into the removable non-volatile memory in the information backup device [102]; and
a different handheld device [204] including a memory for receiving and rewriting the information from the removable non-volatile memory into the memory in the different handheld device [204].

12. The system as claimed in claim 11 wherein the information backup device [102] is for receiving information through a hardwire, wirelessly, a universal serial bus connector, or a combination thereof [110, 210, 506].

13. The system as claimed in claim 11 wherein the removable non-volatile memory is for operation in both the information backup device [102] and the different information backup device [202].

14. The system as claimed in claim 11 further comprising a computer [502] for operation with the information backup device [102] and the different information backup device [202].

15. The system as claimed in claim 11 wherein the information backup device [102] is for automatically identifying the handheld device [104] and the different handheld device [204].

16. An information backup system [100] comprising:
a handheld device [104] including a memory for sending communication information and releasing data information from the memory after receiving responding communication information;
an information backup device [102] for providing responding communication information from the information backup device to the handheld device [104] and writing the data information into a removable non-volatile memory in the information backup device [102]; and
a different handheld device [204] including a memory for sending communication information and writing data information from the removable non-volatile memory in the memory of the different handheld device after receiving responding communication information.

17. The system as claimed in claim 16 wherein the information backup device [102] is for receiving and writing the data information through a hardwire, wirelessly, a universal serial bus connector, or a combination thereof [110, 210,506].

18. The system as claimed in claim 16 wherein the removable non-volatile memory is for operation with the information backup device [102] for the handheld device [104] and the different information backup device [202] for the different handheld device [204].

19. The system as claimed in claim 16 further comprising a personal computer [502] for computer [502] for operation with the information backup device [102], the handheld device [104], the different information backup device [202], and the different handheld device [204].

20. The system as claimed in claim 16 wherein the information backup device [102] is for automatically identifying and assuring compatibility between the handheld device [104] and the different handheld device [204].
